(19) United States
(12) Patent Application Publication
(10) Pub. No.: US 2019/0092448 A1
(43) Pub. Date: Mar. 28, 2019

(54) TAIL-LESS UNMANNED AERIAL VEHICLE

(71) Applicant: LEONARDO S.P.A., Roma (IT)

(72) Inventors: Aurelio Calcedonio BOSCARINO, Torino (IT); Alberto BECCARO, Vercelli (IT); Pierclaudio IAIA, Varese (IT); Nicola Italo CATINO, Rivoli (TO) (IT); Diego CURLETTO, Collegno (TO) (IT); Davide DE SIMONE, Torino (IT); Luciana LO VERDE, Collegno (TO) (IT); Paolo DI STEFANO, Torino (IT); Silva REGIS, Rivoli (TO) (IT); Riccardo BARGETTO, Torino (IT)

(73) Assignee: LEONARDO S.P.A., Roma (IT)

(21) Appl. No.: 16/086,579

(22) PCT Filed: Mar. 17, 2017
(86) PCT No.: PCT/IB2017/051553

§ 371 Date: Sep. 19, 2018

(30) Foreign Application Priority Data
Mar. 21, 2016 (IT) 102016000029062

(51) Int. Cl. B64C 3/14; B64C 39/02; B64C 25/14

(52) U.S. Cl. CPC B64C 3/14; B64C 39/024; B64C 25/14; B64C 2201/021; B64C 2201/044; B64C 2201/086; B64C 2201/22; B64C 2201/126; B64C 2201/127; B64C 2201/146; B64C 2201/165; B64C 2201/187; B64C 2201/104

(57) ABSTRACT

An aerial vehicle includes a fuselage situated at the center and a main wing body having a pair of half-wings extending on transversely opposite sides of the fuselage. Each half-wing includes an orientable horizontal surface or plane, which acts as an aerodynamic control, and a fixed winglet.

### TECHNICAL FIELD

The present invention relates to a tail-less unmanned aerial vehicle.

### TECHNOLOGICAL BACKGROUND

A so-called “tail-less” aerial vehicle is an aerial vehicle without an assembly of tailplanes and empennages, which typically serves stabilizing purposes and includes horizontal surfaces or planes (for example, including a fixed stabilizer and a movable elevator, in particular hinged relative to the stabilizer). In a tail-less aerial vehicle, on the other hand, the only horizontal surfaces or planes available are mounted in the main wing and fulfill functions of aerodynamic control and stabilization.

Applications of tail-less aerial vehicles are known, which are defined as UAV/RPAS (“unmanned aerial vehicle”/“remotely piloted aircraft system”), which are also commonly called drones. By definition, these aerial vehicles do not request the presence of a crew on board, as the pilot controls the aerial vehicle from a remote position. The use of this type of aerial vehicles is well-established and can count on numerous operating applications in the civil and military field.

UAV tail-less aerial vehicles typically use a “flying wing” configuration, which usually has a triangular or rhomboidal configuration.

### SUMMARY OF THE INVENTION

An object of the present invention is to provide a configuration of a tail-less unmanned aerial vehicle, which is capable of optimizing the endurance, ensuring at the same time a reduced radar marking.

According to the present invention, unlike the solutions of UAV tail-less vehicles using a flying wing structure, the aerial vehicle according to present invention ensures, indeed, high flexibilities in terms of payload (sensors, armament, fuel) for different operating uses as well as numerous advantages in the entire life cycle of the product (inspections, ability to be disassembled, etc.).

According to the present invention, this and other objects are reached by means of an aerial vehicle having the technical features set forth in appended independent claim.

The appended claims are an integral part of the technical teaches provided in the following detailed description concerning the present invention. In particular, the appended dependent claims define some preferred embodiments of the present invention and describe optional technical features thereof.

Further features and advantages of the present invention will be best understood upon perusal of the following detailed description, which is provided by way of example and is not limiting, with reference, in particular, to the accompanying drawings, which are briefly described below.

### BRIEF DESCRIPTION OF THE DRAWINGS

FIG. 1 is a perspective front view of an aerial vehicle according to an exemplary embodiment of the present invention.

FIG. 2 is a rear perspective view of an aerial vehicle shown in FIG. 1.

FIG. 3 is a plan view from the top of the aerial vehicle shown in the previous figures.

FIG. 4 is a front elevation view of the aerial vehicle shown in the previous figures.

FIG. 5 is a side elevation view of the aerial vehicle shown in the previous figures.

FIG. 6 is a schematic plan view from the top of the aerial vehicle shown in the previous figures.

FIGS. 7a and 7b are schematic perspective views showing different operating conditions of a winglet of the aerial vehicle shown in the previous figures.

FIGS. 8 and 9 are perspective views, a front view and a rear view respectively, of an aerial vehicle according to a further exemplary embodiment of the present invention.

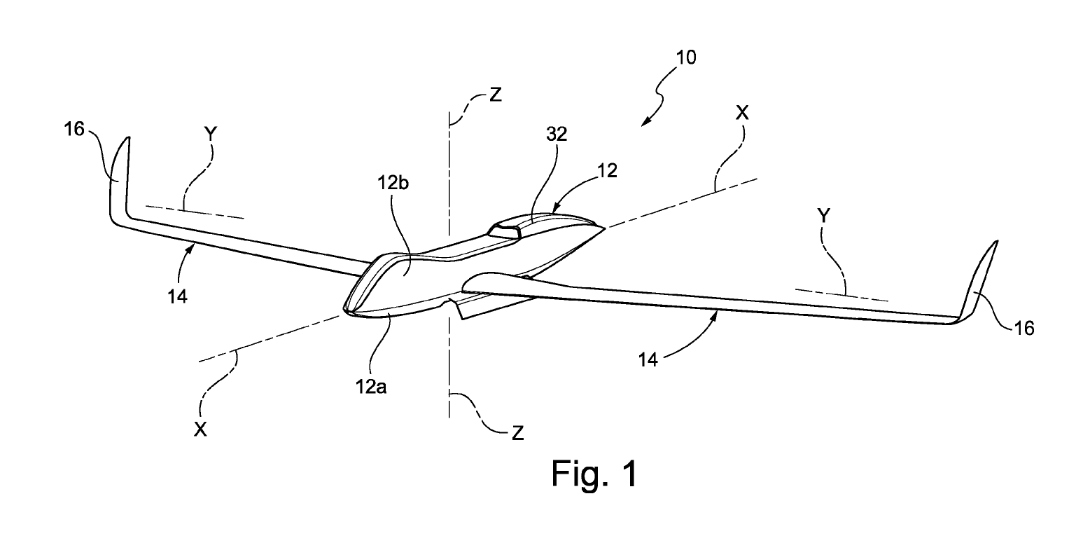

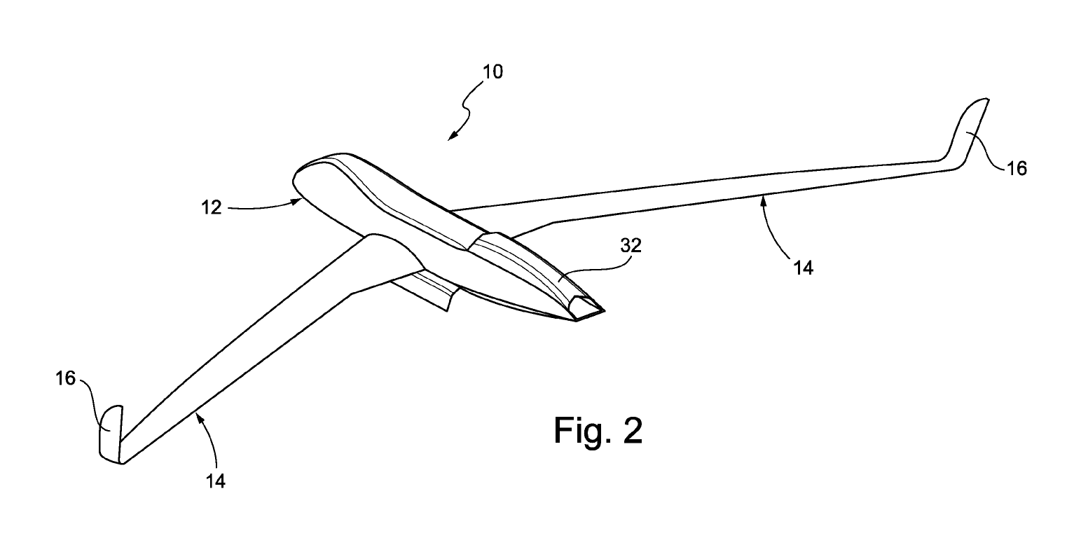

### DETAILED DESCRIPTION OF THE INVENTION

With reference to figures from 1 to 6 and 7a-b, the numeral 10 indicates, as a whole, an aerial vehicle manufactured according to an exemplary embodiment of the invention.

The aerial vehicle 10 is a tail-less unmanned aerial vehicle (UAV).

The aerial vehicle 10 comprises a fuselage 12 situated at the center and a main wing body comprising a pair of half-wings 14, each extending on opposite sides of the fuselage 12.

In the embodiment shown, the fuselage 12 comprises a ventral or lower portion 12a (operatively facing downwards in normal flying conditions) and a dorsal or upper portion 12b (operatively facing upwards in normal flying conditions).

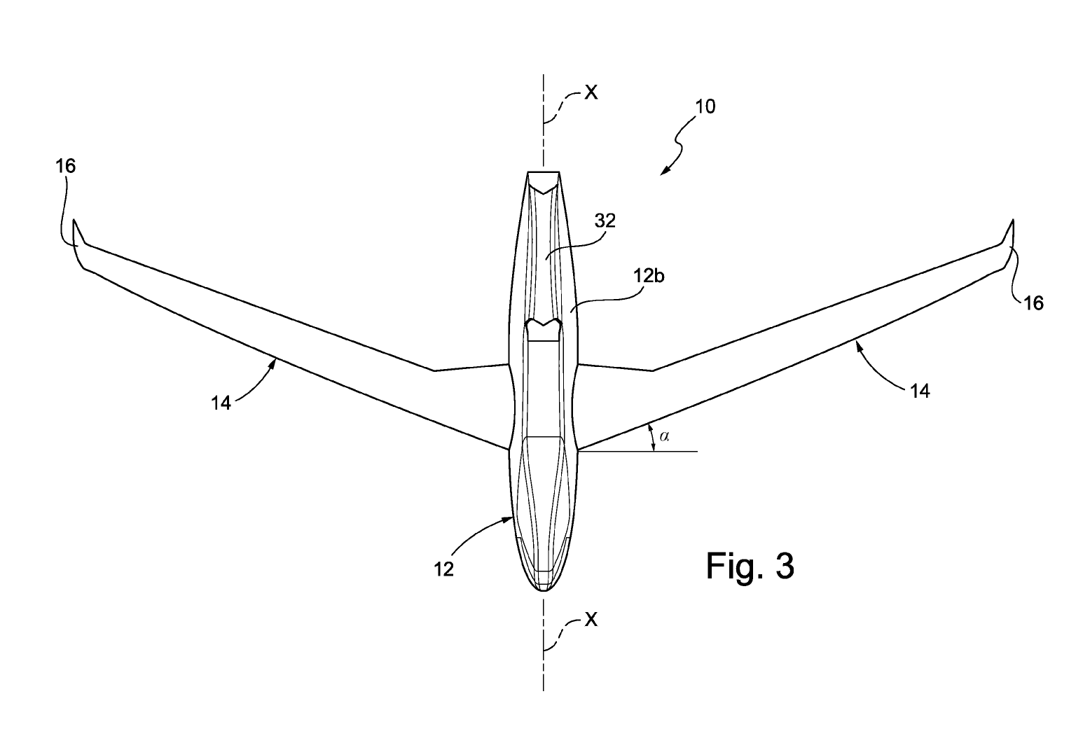

In the embodiment shown, with special reference to FIG. 3, the ventral portion 12a and the dorsal portion 12b have a cross section with a variable width along the longitudinal axis X-X of the fuselage 12. However, by way of example, the shape of the respective cross sections of the ventral portion 12a and of the dorsal portion 12b have an almost trapezoidal shape, in particular having a coinciding main or long base. These cross sections are properly shaped and joined, so as to fulfill different operating needs (for example aerodynamic efficiency, functionality of the equipment, electromagnetic, thermal and acoustic markings, etc.).

With reference in particular to FIG. 3, each half-wing 14 has the same swept wing. This swept wing is determined as the technical result of the best compromise among aeromechanical aspects, structural aspects and electromagnetic marking aspects. In particular, the sweep angle “α” of the leading edge ranges from 10° to 50°.

Each one of the half-wings 14 has a high aspect ratio and is provided with orientable horizontal surfaces or planes which are per se known (therefore, are not needed to be shown in the drawings), which act as aerodynamic and stability control of the aerial vehicle 10. For example, these surfaces are properly positioned on the trailing edge of the half-wing 14. Preferably, these surfaces are absent on the leading edge of the half-wing 14.

As already mentioned above, the aerial vehicle 10 is not provided with empennages situated on the tail or the bow of the fuselage 12 (for example canards or the like).

In the embodiment shown, each one of the distal ends of the half-wings 14 comprises a winglet 16. The winglets 16 improve the overall aerodynamic efficiency of the half-wing 14, decreasing the lift-induced drag caused by wingtip vortices.

In the embodiment shown, each winglet 16 has a vertical extension according to a direction that is substantially perpendicular to the rest of the half-wing 14. In particular, the winglet 16 is properly angled relative to the perpendicular to the rest of the half-wing 14. More in detail, each winglet 16 is preferably slightly angled outwards relative to a perpendicular to the rest of the half-wing 14.

In the embodiment shown, each winglet 16 is fixed, so that it is not capable of being moved relative to the respective half-wing 14, and it is not provided with movable surfaces.

Both the absence of traditional empennages situated on the tail of the fuselage 12 to control the flight and the absence of movable surfaces on the winglet 16 lead to a reduction of the radar marking and of the drag of the aerial vehicle 10.

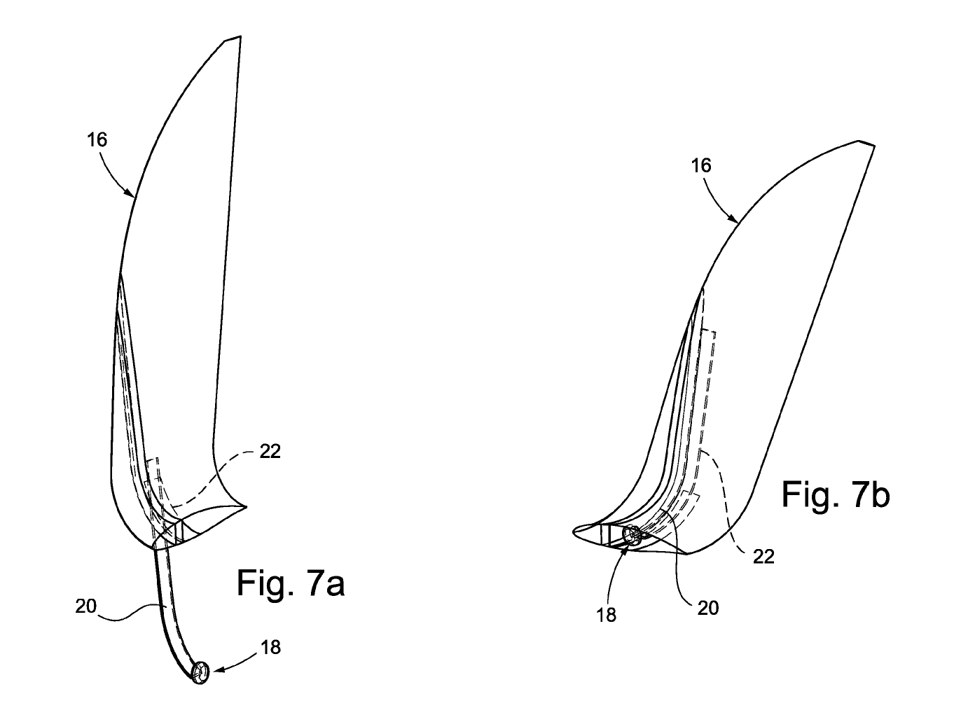

Furthermore, as it is shown in FIGS. 7a and 7b, the aerial vehicle 10 comprises a pair of underwing wheels 18, which are retractable in the winglets 16. The underwing wheels 18 can be moved between an extracted position (FIG. 7a) and a retracted position (FIG. 7b). In the extracted position, the underwing wheels 18 are configured to roll while resting on the ground, so as to contribute in supporting the aerial vehicle 10 on the sides. In the retracted position, the underwing wheels 18 are configured to remain at a distance from the ground, without contributing in supporting the aerial vehicle 10 on the sides. The movement of the underwing wheels 18 is carried out, for example, by operating hydraulic or electric actuators.

In particular, each one of the underwing wheels 18 is mounted on a movable frame 20, which is slidable in a controlled manner along the respective winglet 16.

In particular, the movable frame 20 has a shape which is substantially complementary to the region joining the winglet 16 to the rest of said half-wing 14. In the embodiment shown, the movable frame 20 substantially has the shape of a J or an L, the respective underwing wheel 18 being mounted on the distal end of said J or L.

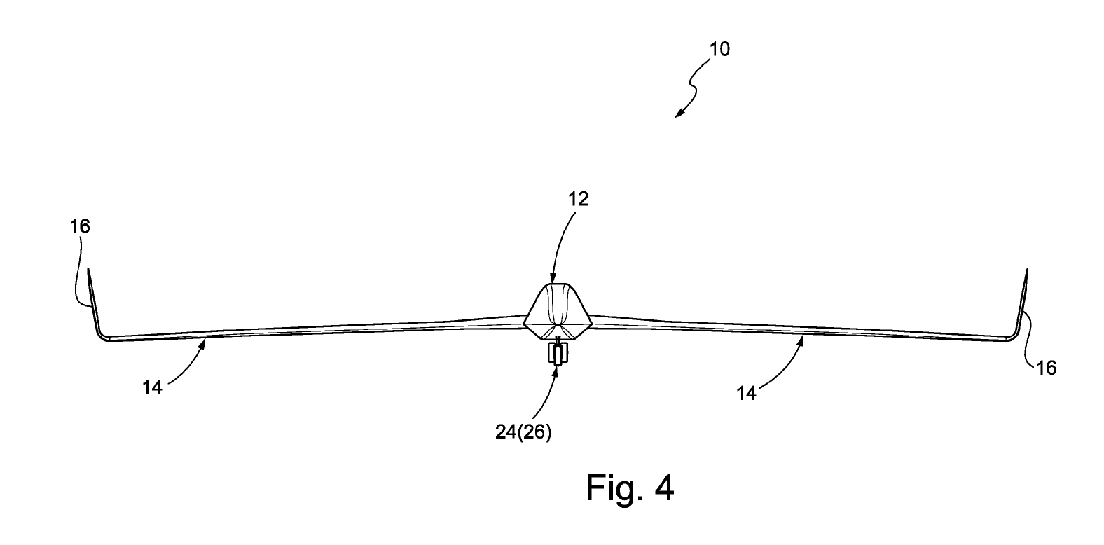

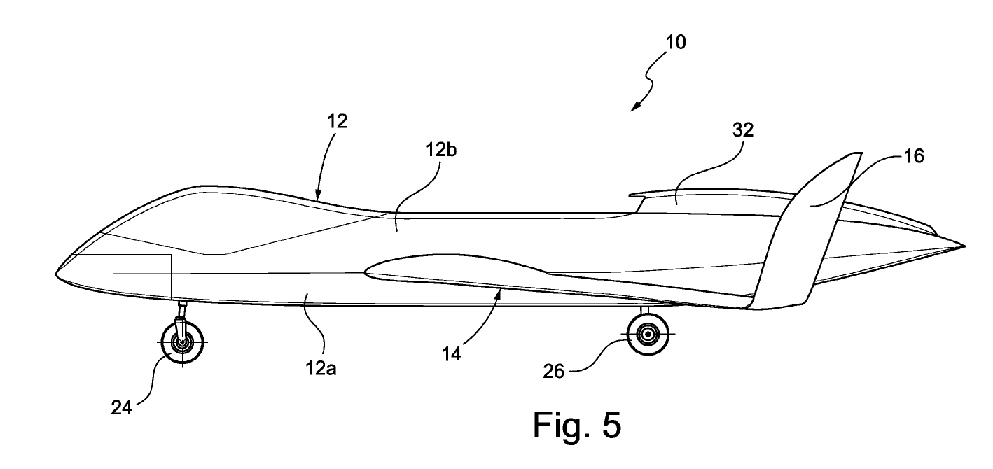

Preferably, when the underwing wheel 18 and the relative movable frame 20 are in the retracted position, they are completely inserted and received “in a concealed manner” in a respective housing 22 which is complementarily recessed in the region joining the winglet 16 to the rest of the half-wing 14 (see FIG. 7b). The aerial vehicle 10 comprises, furthermore, a landing gear system (shown, in particular, in FIGS. 4 and 5), which is retractable in the fuselage 12 and, therefore, is configured to support the central part of the aerial vehicle when it is not flying.

Preferably, the landing gear system is a bicycle-type landing gear comprising a nose landing gear 24 and a main landing gear 26, both provided with wheels (not numbered).

In the embodiment shown, the landing gears 24, 26 are aligned along the longitudinal axis X-X of the fuselage 12.

In particular, the landing gears 24 and 26 are mounted at the front and at the back, respectively, of the fuselage in a retractable manner. More in detail, the landing gears 24, 26 are mounted between an extracted (or operating) condition and a retracted (or storing) condition relative to the fuselage 12.

Preferably, the landing gears 24, 26 are retractable in a single compartment (not shown) situated in the ventral part of the fuselage 12, in particular has a mainly longitudinal extension in the median part thereof.

In the embodiment shown, the compartment is opened and closed in a controlled manner by means of sliding or leaf doors (not shown) situated in the ventral part of the fuselage 12, so as to project outwards the landing gears 24, 26 and respectively store on the inside such landing gears.

The arrangement comprising the landing gear system and the underwing wheels 18 allows manufacturers to optimize the airfoil as well as the space taken up by the compartment 28 used to receive the landing gears 24, 26.

Furthemore, this arrangement simplifies the kinematics and the dynamics of the mechanism used to move the landing gears 24, 26 and the respective doors, with benefits for the overall radar marking. In particular, as already mentioned above, this solution advantageously permits to store the landing gears 24, 26 in the fuselage 12 and to store each one of the underwing wheels 18 in the respective winglet 16.

Furthermore, it is advantageously possible to make one single control system for the landing gears 24, 26, for example including means for mechanical actuating and locking, means for warning about correct attitude and locking, means for operating the relative doors, etc. Furthermore, the preferred use of one single compartment situated in the ventral part of the fuselage 12 allows manufacturers to distribute the volumes of the fuel bays in the wings. As a matter of fact, the quantity of fuel to be totally housed in the fuselage 12 is reduced—which leads to lightening structural effects during the flight.

Furthermore, each one of the landing gears 24, 26 preferably has a respective and autonomous steering system, which encourages a safe control during the taking off and the landing of the aerial vehicle 10, even with a strong transverse wind.

Preferably, the aerial vehicle 10 further comprises a detection system arranged for detecting or determining the presence of objects or targets close to the aerial vehicle while it is flying.

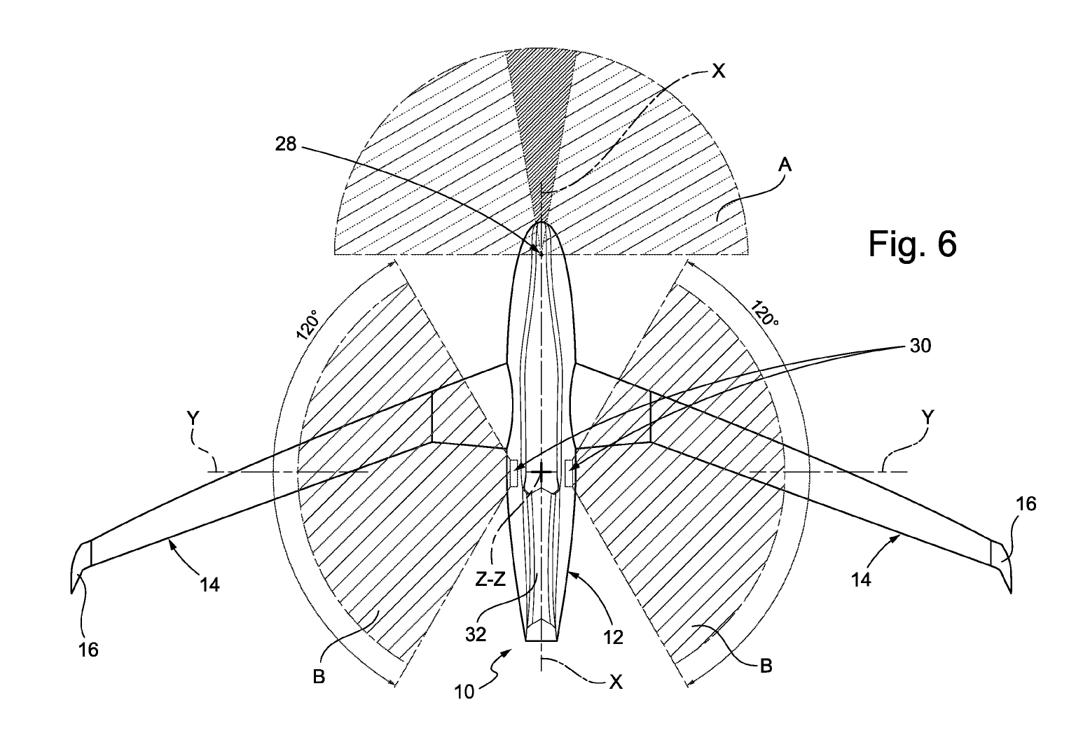

In particular, the detection system uses a plurality of radar devices installed on the fuselage 12. In the embodiment shown, with reference in particular to FIG. 6, the detection system comprises a front radar device 28 and a pair of lateral radar devices 30 installed on the fuselage 12.

The front radar device 28 is situated at the front, in particular in a bow position, in the fuselage 12.

The lateral radar devices 30 are situated on the side of the fuselage 12 and behind the front radar device 28. In particular, the lateral radar devices 30 are situated on transversely opposite sides of the fuselage 12, behind the half-wings 14.

In the embodiment shown, the radar devices 28, 30 are situated in the ventral portion 12a of the fuselage 12.

Preferably, the front radar device 28 has a front azimuthal scanning range A (indicated with a broken line in FIG. 6) of approximately 180°, in particular centered on the longitudinal axis X-X of the fuselage 12.

Preferably, each of the lateral radar devices has a lateral azimuthal scanning range B (indicated with a broken line in FIG. 6) of approximately 120°, in particular centered on a transverse axis Y-Y of the fuselage 12. Said transverse axis Y-Y is perpendicular to the longitudinal axis X-X and is preferably situated behind the half-wings 14.

Optionally, the embodiment shown ensures the possibility to change, in a controlled manner, the position of the front radar device 28 in elevation relative to the transverse axis Y-Y of the fuselage 12 (namely, relative to the plane XZ) and/or in azimuth relative to a vertical axis Z-Z of the fuselage 12 (namely, relative to the plane XY). This possibility of movement is obtained, for example, by means of a gimbal fitting on the fuselage 12.

In the embodiment shown, the position of the lateral radar devices 30 is fixed.

Preferably, the radar devices 28, 30 are mounted on the inside of the fuselage 12, thus avoiding outer fuselage fairings on the outside of the profile. This allows a simultaneous improvement of the aerodynamics and of the radar marking of the aerial vehicle 10.

The large azimuthal coverage and the elevation scanning ability offered by the detection system of the aerial vehicle 10 enables advanced features known as “situational awareness” and “sense & avoid”. Hence, in particular, the aerial vehicle 10 supports the integration in non-segregated airspaces and with presence of non-cooperative aircrafts, in particular “intruders” (namely, aircrafts that are not equipped with transponders). Therefore, this detection system solution allows an azimuthal scanning greater than 300°, thus covering view sectors that are currently valid for traditional aircrafts with on-board crew.

In the embodiment shown by the invention, the engine of the aerial vehicle is a turbine 32 and is mounted, by way of example, at the back of the fuselage 12.

Preferably, the turbine 32 is mounted in the dorsal part of the fuselage 12.

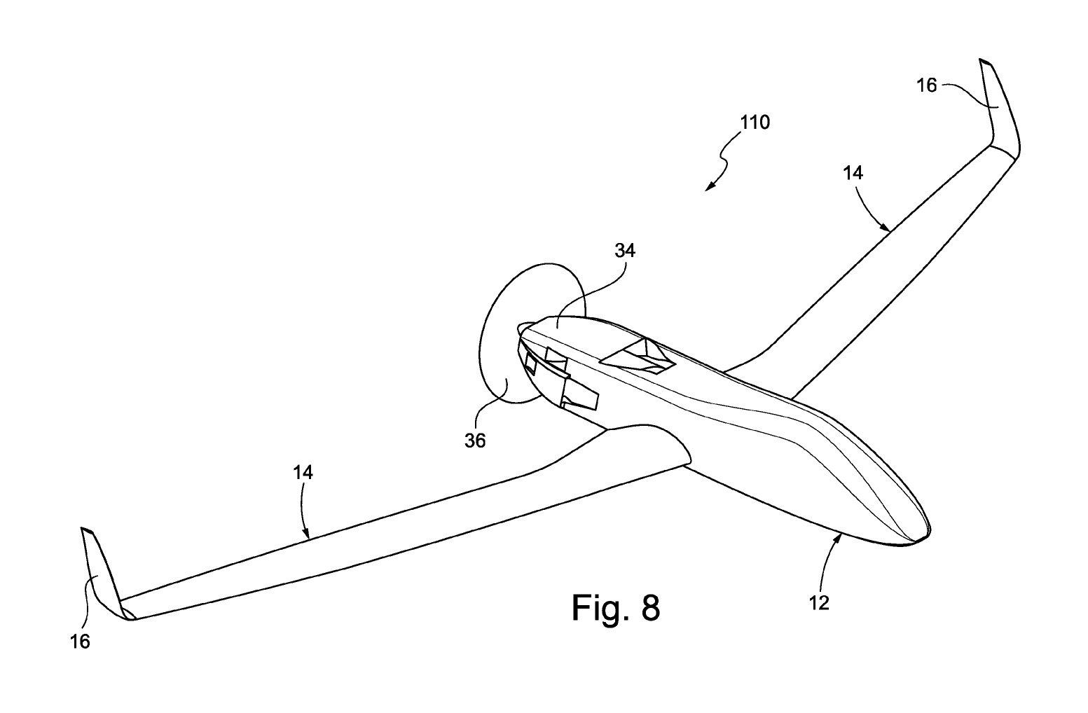

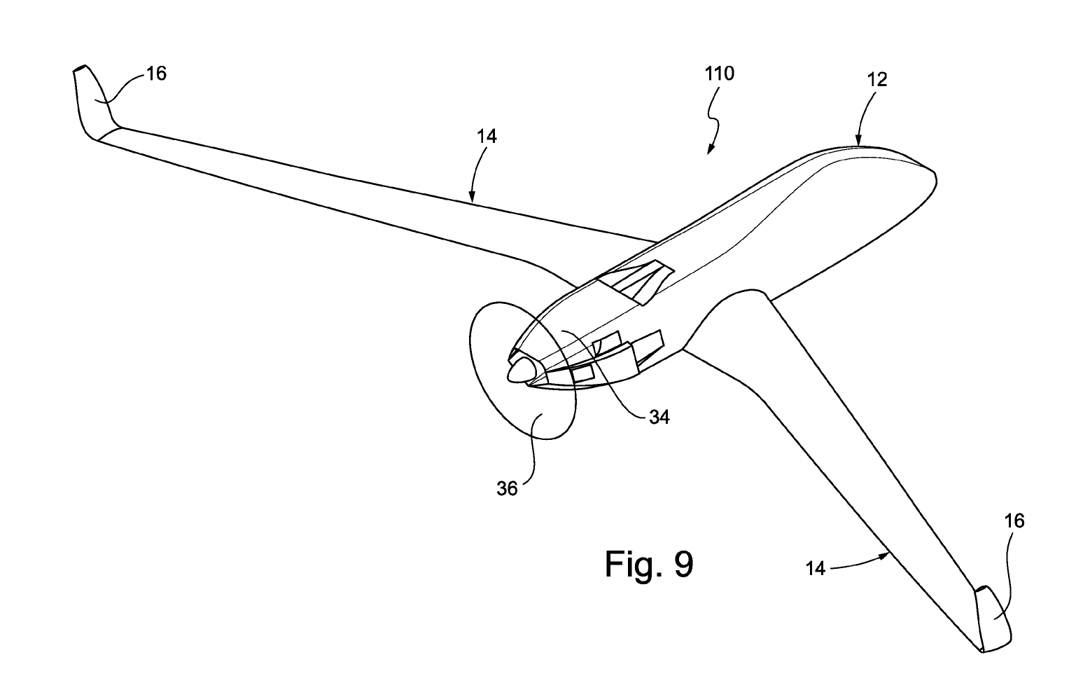

With reference to FIGS. 8 and 9, number 110 indicates, as a whole, an aerial vehicle manufactured according to a further exemplary embodiment of the invention. This embodiment is alternative to the one shown in the previous figures.

Details and elements that are similar to those of the embodiment described above—or fulfill a similar function—are associated with the same alphanumeric references. For the sake of conciseness, the description of these details and elements will not be repeated below, but reference will be made to what was previously explained in the description of the previous embodiment.

In FIGS. 8 and 9, the engine of the aerial vehicle 110 is a reciprocating engine 34, in particular operated by pistons.

Furthermore, the reciprocating engine 34 is situated at the back of the fuselage 12. For example, the reciprocating engine 34 is situated in the area of the stern of the fuselage 12. In the embodiment shown, the reciprocating engine 34 has a driven shaft, which is integral to a blade propeller, which is rotatable substantially about the longitudinal axis X-X of the fuselage 12.

Optionally, in the embodiment shown, a tricycle landing gear system is also applicable. According to this variant, there can be a main landing gear (not numbered), which is mounted in a retractable manner on the two half-wings 14—instead of the fuselage 12.

Naturally, the principle of the invention remaining the same, the embodiments and the implementation details can be widely varied with respect to what has been described above and shown in the drawings by way of a non-limiting example, without departing from the scope of protection defined in the accompanying claims.

1. A tail-less unmanned aerial vehicle; said aerial vehicle comprising a center fuselage and a main wing body comprising a pair of half-wings extending on transversely opposite sides of said fuselage; each one of said half-wings comprising at least one orientable horizontal surface or plane, which acts as an aerodynamic control, and a fixed winglet.

2. The aerial vehicle according to claim 1, wherein each one of said half-wings is a swept wing.

3. The aerial vehicle according to claim 2, wherein each one of said half-wings has a sweep angle of the leading edge ranging from 10° to 50°.

4. The aerial vehicle according to claim 1, wherein each winglet extends vertically or inclined relative to a rest of the respective half-wing.

5. The aerial vehicle according to claim 1, wherein each one of said half-wings comprises an underwing wheel, which is retractable in the respective winglet.

6. The aerial vehicle according to claim 5, wherein each one of the underwing wheels is mounted on a movable frame, which is controllably slidable along the respective winglet.

7. The aerial vehicle according to claim 6, wherein said movable frame has a shape substantially complementary to a region joining said winglet to a rest of said half-wing.

8. The aerial vehicle according to claim 7, wherein said movable frame has substantially a shape of a J or an L, the respective underwing wheel being mounted on a distal end of said J or L.

9. The aerial vehicle according to claim 7, wherein, when said underwing wheel and the relative movable frame are in a retracted position, said underwing wheel and said movable frame are completely inserted and received and concealed in a respective housing complementarily recessed in said region joining the winglet to the rest of the half-wing.

10. The aerial vehicle according to claim 1 and comprising, furthermore, a landing gear.

11. The aerial vehicle according to claim 10, wherein said landing gear is retractably mounted on the fuselage and centrally supports said aerial vehicle.

12. The aerial vehicle according to claim 11, wherein said landing gear comprises a nose landing gear and a main landing gear.

13. The aerial vehicle according to claim 12, wherein said landing gears are aligned along a longitudinal axis of the fuselage.

14. The aerial vehicle according to claim 13, wherein said landing gears are retractable in a single compartment situated in a ventral part of said fuselage.

15. The aerial vehicle according to claim 14, wherein said compartment has a mainly longitudinal extension in a median part of said fuselage.

16. The aerial vehicle according to claim 14, wherein said compartment is opened and closed in a controlled manner by at least one door situated in the ventral part of said fuselage.

17. The aerial vehicle according to claim 10, wherein said landing gear is mounted in a retractable manner in an area of said half-wings.

18. The aerial vehicle according to claim 1 comprising, furthermore, a detection system arranged for detecting or determining the presence of objects or targets close to the aerial vehicle.

19. The aerial vehicle according to claim 18, wherein the detection system comprises a plurality of radar devices.

20. The aerial vehicle according to claim 19, wherein the detection system comprises a front radar device and at least one lateral radar device installed on each side of the fuselage.

21. The aerial vehicle according to claim 20, wherein said front radar device is situated in a bow position, in the fuselage.

22. The aerial vehicle according to claim 21, wherein said at least one lateral radar device is situated on one of the sides of the fuselage and behind said front radar device.

23. The aerial vehicle according to claim 21, wherein said at least one lateral radar device is situated behind the half-wings.

24. The aerial vehicle according to claim 19, wherein said radar devices are situated in a ventral portion of said fuselage.

25. The aerial vehicle according to claim 20, wherein the front radar device has a front azimuthal scanning range of approximately 180°.

26. The aerial vehicle according to claim 25, wherein said front range is centered on a longitudinal axis of said fuselage.

27. The aerial vehicle according to claim 20, wherein said at least one lateral radar device has a lateral azimuthal scanning range of approximately 120°.

28. The aerial vehicle according to claim 27, wherein said lateral range is centered on a transverse axis of said fuselage.

29. The aerial vehicle according to claim 20, wherein said front radar device is movable, in a controlled manner, in at least one parameter selected between:
altitude relative to the transverse axis, and
azimuth relative to a vertical axis of said fuselage.

30. The aerial vehicle according to claim 20, wherein said at least one lateral radar device is mounted in a fixed manner.

31. The aerial vehicle according to claim 1 and comprising, furthermore, an engine.

32. The aerial vehicle according to claim 31, wherein said engine is situated at a back of the fuselage.

33. The aerial vehicle according to claim 32, wherein said engine is mounted in a dorsal part of said fuselage.

34. The aerial vehicle according to claim 32, wherein said engine is mounted in an area of a stern of said fuselage.

35. The aerial vehicle according to claim 31, wherein said engine is a turbine.

36. The aerial vehicle according to claim 31, wherein said engine is a reciprocating engine.
